(19) United States
(12) Patent Application Publication
(10) Pub. No.: US 2006/0212205 A1
(43) Pub. Date: Sep. 21, 2006

(54) Method for detecting when a vehicle is in a downhill situation

(75) Inventors: Ying Yang, Rochester Hills, MI (US); Clinton Lee Schumann, Royal Oak, MI (US)

Correspondence Address: BRINKS HOFER GILSON & LIONE, P.O. BOX 10395, CHICAGO, IL, 60610, US

(73) Assignee: CONTINENTAL TEVES, INC.

(21) Appl. No.: 11/079,997

(22) Filed: Mar. 15, 2005

(51) Int. Cl. G06G 7/76; G06F 19/00

(52) U.S. Cl. 701/70

(57) ABSTRACT

A system providing protection to a power steering assist circuit in the event of a reversal of polarity of the power supply is disclosed. The circuit has a solenoid, a recirculating diode in an electrically parallel connection with the solenoid, and a protection device connected in electrical series with the recirculating diode. The protection device may be an n-channel field effect transistor. A power supply having a positive terminal connected to the circuit and negative terminal connected to the ground provides power to the circuit. In the event that the negative terminal of the power supply is connected the circuit and the positive terminal of the power supply is connected to the ground, the protection device will prevent the flow of current through the recirculating diode.

### BACKGROUND OF THE INVENTION

Modern motor vehicles are often equipped with “active braking” systems in which individual wheel brakes are actuated and/or released under microprocessor control to prevent wheel lockup and undesirable wheel slip values. These active braking systems typically include wheel speed sensors and electrically controlled regulating valves which modulate the supply of pressurized hydraulic fluid to each wheel's brake cylinder.

Modern motor vehicles and particularly vehicles desired for off-road use, such as sport utility vehicles (“SUVs”) are also often equipped with “hill decent control” (“HDC”) systems in which individual wheel brakes are actuated and/or released and the lowest possible drive transmission gear is engaged and/or disengaged under microprocessor control. Engaging the lowest possible transmission gear allows the engine of the vehicle to slow the vehicle's wheels, which is referred to as “engine braking”. HDC systems automatically actuate the wheel brakes to supplement engine braking on steep descending slopes in order to maintain a specified low speed for maintaining control of the vehicle.

HDC systems are typically manually activated by the driver. This is because the methods used to control the actuation of the brakes and the engagement of the transmission gears when descending a steep slope are different from the methods used to actuate the brakes when the vehicle is traveling along a normal road surface. There exists a need to automatically engage the HDC system when the vehicle is descending a hill or slope and to automatically disengage the HDC system when vehicle is traveling along a flatter surface.

### BRIEF SUMMARY OF THE INVENTION

In satisfying the above need, a method for determining if a vehicle is in a downhill situation is provided. The primary components required in order for the method to execute are an electronic control unit (“ECU”), wheel speed sensors in electrical communication with the ECU and capable of measuring the speed of each wheel of the vehicle, and a longitudinal accelerometer in electrical communication with the ECU and capable of determining the longitudinal acceleration of the vehicle. Longitudinal accelerometers are typically present in motor vehicles having modern electronic braking systems providing one or more of the following capabilities: anti-lock braking (“ABS”), traction control system (“TCS”), electronic stability program (“ESP”) and active-rollover protection (“ARP”).

In accordance with this invention, to determine if a vehicle is a downhill situation, the ECU will determine a wheel speed vehicle acceleration value by evaluating the wheel speed sensors over a period of time. Next, a threshold value based on a reading provided by a longitudinal accelerometer and the wheel speed vehicle acceleration value is determined by the ECU. This threshold value will be compared to a first downhill value which is indicative of the vehicle positioned on a slope. If the threshold value is greater than the first downhill value, a downhill counter will be increased. Subsequently, the threshold value will be compared to a first flat value which is indicative of the vehicle positioned on a flat relatively surface. If the threshold value is less than the first flat value, a downhill counter will be decreased. Finally, the downhill counter will be compared to a downhill situation value which is indicative of when the vehicle is positioned on a slope. If the downhill counter is greater than the downhill situation value, the vehicle is determined to be in a downhill situation.

In another embodiment of the invention, the threshold value will be calculated by the ECU by subtracting the longitudinal accelerometer reading from the vehicle acceleration value.

In another embodiment of the invention, the method further includes increasing the downhill counter if the threshold value is greater than a second downhill value. The second downhill value is indicative of a slope steeper than the slope represented by the first downhill value.

In still yet another embodiment of the invention, the method further includes decreasing the downhill counter if the threshold value is less than a second flat value. The second flat value represents a surface that is flatter than the surface represented by the first flat value.

### BRIEF DESCRIPTION OF THE DRAWINGS

FIG. 1 is a block diagram of an automobile system for determining if the vehicle is in a downhill situation; and

FIGS. 2A and 2B are a flow chart illustrating the method executed by the system to determine if the vehicle is in a downhill situation.

### DETAILED DESCRIPTION OF THE INVENTION

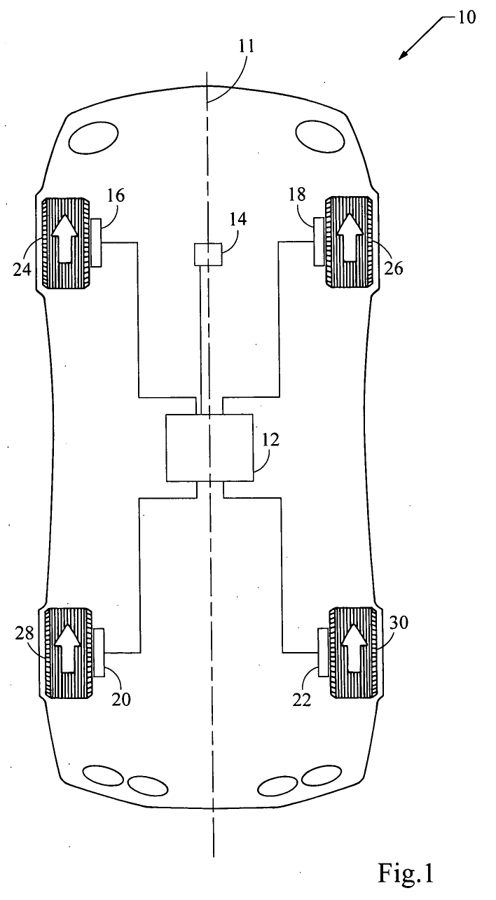

Referring now to FIG. 1, a vehicle 10 is diagrammatically shown. The vehicle 10 includes an electronic control unit (“ECU”) 12, a longitudinal accelerometer 14, a front driver-side wheel speed sensor 16, a front passenger-side wheel speed sensor 18, a rear driver-side wheel speed sensor 20, and a rear passenger-side wheel speed sensor 22. The longitudinal accelerometer 14 is in electrical communication with the ECU 12. The longitudinal accelerometer 14 will communicate to the ECU 12 the longitudinal acceleration of the vehicle 10 along a longitudinal centerline 11 (i.e. the fore-and-aft acceleration of the motor vehicle).

The wheel speed sensors 16, 18, 20 and 22 are in independent electrical communication with the ECU 12. The wheel speed sensors 16, 18, 20 and 22 will communicate the wheel speed of wheels 24, 26, 28 and 30, respectively.

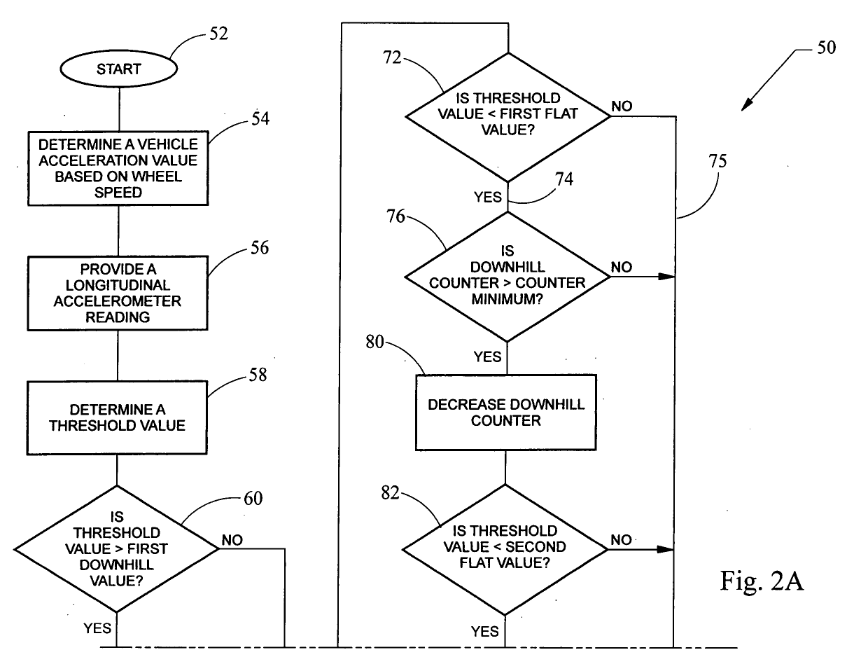

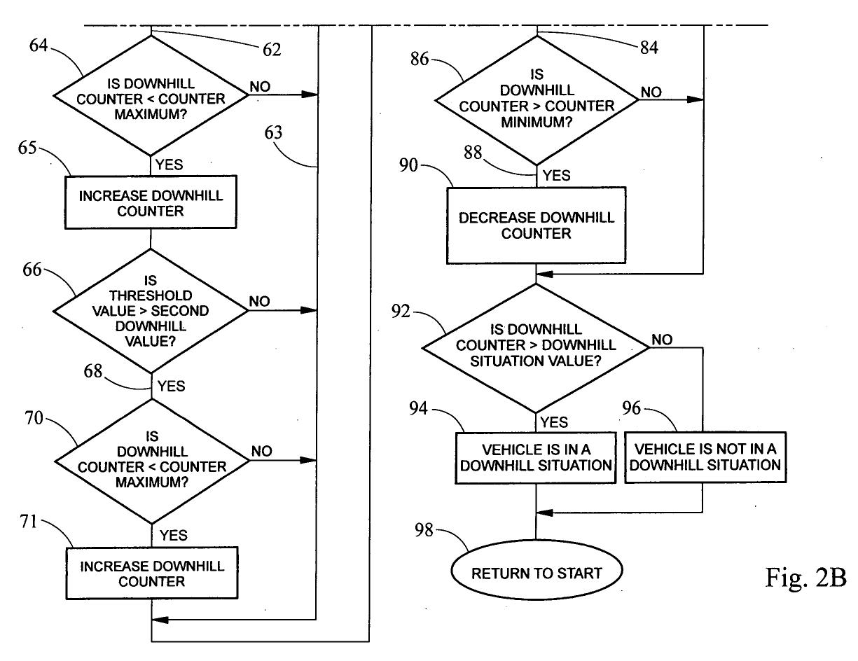

Referring now to FIGS. 2A and 2B, a method for determining if a vehicle is in a downhill situation is provided at reference numeral 50. Block 52 denotes the start of the method. In block 54, a wheel speed vehicle acceleration value is determined by the ECU. The wheel speed vehicle acceleration value is representative of the vehicle's acceleration based on input from the wheel speed sensors by evaluating the wheel speed sensors over a period of time.

In block 56, the longitudinal accelerometer provides the ECU with a longitudinal accelerometer reading. The longitudinal accelerometer reading directly measures the vehicle's longitudinal acceleration (i.e. the fore-and-aft acceleration of the motor vehicle).

Next, as shown in block 58, a threshold value is determined by having the ECU by calculating the difference between the longitudinal accelerometer reading and the wheel speed vehicle acceleration value. The threshold value is representative of the acceleration of the vehicle caused by having the vehicle positioned on a slope. For example, if the vehicle is positioned on a slope and not moving, the wheel speed vehicle acceleration value will be zero but the longitudinal accelerometer reading will represent a component of gravity from the slope; thus, the threshold value will be greater than zero. Conversely, if the vehicle is traveling on a flat surface and under a period of acceleration caused by slowing the vehicle, the wheel speed vehicle acceleration value and the longitudinal acceleration reading will be roughly equal; thus, the threshold value will be near zero.

In block 60, the threshold value is compared to a first downhill value. The first downhill value is a value representative of the vehicle descending a slope of approximately 20% grade, which is indicative of a vehicle in a downhill situation. However, the first downhill value can be adjusted to represent other grades. If the threshold value is greater than the first downhill value, the method follows line 62 to block 64. Otherwise, the method will follow line 63.

In block 64, a downhill counter will be compared to a counter maximum. If the downhill counter is less than the counter maximum, the method continues to block 65, where the downhill counter will be increased. Otherwise, the method continues to line 63. Preventing the downhill counter from exceeding the counter maximum will prevent the method from increasing the downhill counter to a very large value in the event that the vehicle is in a downhill situation for an extended period of time.

After block 65, the method goes to block 66 where the threshold value is compared to a second downhill value. The second downhill value is representative of a larger slope and thus is greater than the first downhill value. The second downhill value is a value representative of the vehicle descending a slope of approximately 37% grade, which is indicative of a vehicle in a downhill situation on a very steep slope. However, the second downhill value can be adjusted to represent other grades. If the threshold value is greater than the second downhill value, the method follows line 68 to block 70. Otherwise, the method will follow line 63. By taking into account the possibility that the vehicle is on a steeper slope, the method can more quickly determine if the vehicle is in a downhill situation.

In block 70, the downhill counter will be compared to the counter maximum. If the downhill counter is less than the counter maximum, the method continues to block 71, where the downhill counter will be increased. Otherwise, the method continues to line 63. Preventing the downhill counter from exceeding the counter maximum will prevent the method from increasing the downhill counter to a very large value in the event that the vehicle is in a downhill situation for an extended period of time.

After block 71 or if the method followed line 63, block 72 is performed. In block 72, the threshold value is compared to a first flat value. The first flat value is representative of the vehicle on a flatter slope. The first flat value is a value representative of the vehicle descending a slope of approximately 18% grade, which is indicative of a vehicle not on a flat surface. However, the first flat value can be adjusted to represent other grades. If the threshold value is less than the first flat value, the method follows line 74 to block 76. Otherwise, the method follows line 75.

Block 76 compares the downhill counter to a counter minimum. If the downhill counter is greater than the counter minimum, then the downhill counter will be decreased as shown in block 80. Otherwise, the method will follow line 75. Preventing the downhill counter from going below the counter minimum will prevent the method from decreasing the downhill counter to a very small or even negative value in the event that the vehicle is not in a downhill situation for an extended period of time.

After block 80, block 82 is performed. In block 82, the threshold value is compared to a second flat value. The second flat value is representative of the vehicle traveling on a slope flatter than the slope representative of the first flat value. The second flat value is a value representative of the vehicle descending a slope of approximately 3% grade, which is indicative of a vehicle on a very flat surface. However, the second flat value can be adjusted to represent other grades. If the threshold value less than the second flat value constant, the method continues along line 84 to block 86. Otherwise, the method follows line 75. By taking into account the possibility that the vehicle is on a flatter surface, the method can more quickly determine if the vehicle is not in a downhill situation.

In block 86, the downhill counter is compared to the counter minimum. If the downhill counter is greater than the counter minimum, the method will follow line 88 to block 90 where the downhill counter will be decreased. Otherwise, the method will follow line 75. Preventing the downhill counter from going below the counter minimum will prevent the method from decreasing the downhill counter to a very small or even negative value in the event that the vehicle is not in a downhill situation for an extended period of time.

After block 90 is performed or if the method is following line 75, block 92 will be performed. In block 92, the downhill counter is compared to a downhill situation value. The downhill situation value is representative of the minimum downhill counter value required to determine if the vehicle is in a downhill situation. As shown by block 94, if the downhill counter is greater than the downhill situation value, the ECU will determine that the vehicle is in a downhill situation. A downhill situation is when the vehicle is on a slope of approximately 20% or greater grade, but this can vary based on customer demands. As shown by block 96, if the downhill counter is less than the downhill situation value, the ECU will determine that the vehicle is not in a downhill situation. A vehicle not in a downhill situation is when the vehicle is on a slope of approximately 18% or less grade, but this can vary based on customer demands. Either way, as represented by block 98, once a determination of the vehicle's downhill situation has been made, the method will return to block 52 and start again. By executing the method 50 continuously, a determination of if the vehicle is in a downhill situation can be made in real-time.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

We claim:

1. A method for determining if a vehicle is in a downhill situation, the method comprising:
determining a vehicle acceleration value from wheel speed sensors;
providing a longitudinal acceleration reading;
determining a threshold value based on the sensor reading and the vehicle acceleration value;
increasing a downhill counter if the threshold value is greater than a first downhill value;
decreasing the downhill counter if the threshold value is less than the first flat value; and
determining the downhill situation by comparing the downhill counter to a downhill indication value.

2. The method in accordance to claim 1, wherein determining the threshold value comprises subtracting the longitudinal accelerometer reading from the threshold value.

3. The method in accordance to claim 1, further comprising increasing the downhill counter if the threshold value is greater than a second downhill value.

4. The method in accordance to claim 3, wherein the second downhill value is greater than the first downhill value.

5. The method in accordance to claim 1, further comprising decreasing the downhill counter if the threshold value is less than a second flat value.

6. The method according to claim 5, wherein the second flat value is greater than the first flat value.
